(19) United States
(12) Patent Application Publication
(10) Pub. No.: US 2025/0226648 A1
(43) Pub. Date: Jul. 10, 2025

(54) BACKUP PROTECTION METHOD

(71) Applicant: Siemens Aktiengesellschaft, München (DE)

(72) Inventors: Wolfgang Erven, Amberg (DE); Karsten Wenzlaff, Dresden (DE); Yi Zhu, Kümmersbruck (DE)

(21) Appl. No.: 18/847,789

(22) PCT Filed: Mar. 2, 2023
(86) PCT No.: PCT/EP2023/055301

§ 371 Date: Sep. 17, 2024

(30) Foreign Application Priority Data
Mar. 17, 2022 (DE) 10 2022 202 653.5

(51) Int. Cl. H02H 3/16; H02H 3/05

(52) U.S. Cl. CPC H02H 3/16; H02H 3/05

(57) ABSTRACT

A method for backup protection in an electrical switchgear. Electrical voltage and/or current values of the switchgear are used to check whether, in a first protective switching device of the switchgear, a switching arc burns for longer than a predetermined period of time. If this is the case, a second protective switching device, which is arranged upstream of the first protective switching device, is caused to trigger.

The present invention relates to a method for backup protection and an arc fault protection unit.

In switching systems, protective switching devices are built up in cascades over distribution levels, in order to distribute electrical energy and to ensure protection of the switching system (lines, switches, etc.) from damage. These protective switching devices can also be designated as protective switching apparatuses, protective devices or simply as protective switches. It is assumed that a protective switching device, for example a circuit breaker or a fuse, functions properly and safely manages a fault such as an over-current or in particular a short circuit and switches off. In the event of failure of a protective switching device, as a rule the backup protection is used, i.e. a higher-order protective switching device clears the fault for the failing protective switching device in the event of a relatively long duration of a short circuit. Often, the backup protection is used in the form in which an under-dimensioned protective switching device (i.e. the level of the short-circuit current exceeds the switching capacity of the protective switching device) in a lower distribution level is also protected by a protective switching device that is placed higher in the hierarchy of the distribution levels and is dimensioned adequately: in this case, to break the short circuit safely, the upstream protective switching device performs the short-circuit protection by triggering.

One problem often lies in the fact that the break times for the backup protection, i.e. in the event of a failure of a protective switching device at a lower distribution level and the backup triggering of a protective switching device at a higher distribution level that is required as a result lie in ranges from >30-50 ms. In such a long time period, however, damage can arise in the switching system, which resembles the damage patterns of small arc fault events and is no longer restricted to the region of the non-functioning switching device. This can lead to greater failures and thus lead to repairs to switching systems becoming necessary.

It is thus an object of the invention to provide improved backup protection.

According to the invention, the object is achieved by a method having the features specified in claim 1. According to the invention, the object is additionally achieved by an arc fault protection unit having the features specified in claim 4. The object is additionally achieved by a computer program having the features specified in claim 9 and a computer program product having the features specified in claim 10.

The method is used for backup protection in an electrical switching system. The switching system can be an electrical energy distribution system, in which electrical energy from an electrical energy source is distributed via a higher-order common main line and from the common main line via a plurality of lower-order output lines and secondary lines. The main line can be disconnected by a main switch, and the output and secondary lines each by an associated circuit breaker or line switch. On the basis of electrical voltage and/or current values of the switching system, a check is made as to whether a switching arc burns for longer than a predefined time interval in a first protective switching device of the switching system. Excessively long burning of a switching arc can be caused, for example, by a defect in a switching mechanism of a protective switching device. For example, there can be a defect of the type in which the contacts, instead of causing final breaking and extinguishing of the switching arc by reaching a sufficient distance from one another, after reaching too small a distance from one another, move toward each other again and increasingly repeat this movement sequence; in this case the switching arc is not extinguished but continues to burn.

After it has been detected, on the basis of electrical voltage and/or current values, that the burn time of a switching arc in the switching system exceeds a predefined threshold value, a second protective switching device, which is arranged upstream of the first protective switching device, is caused to trigger. A second protective switching device of a switching system is arranged upstream of a first protective switching device in the switching system if the current path which extends from the feed point of electrical energy into the switching system to a consumer of the electrical energy runs firstly through the second protective switching device and then through the first protective switching device.

Protective switching devices means, for example, the following devices:
a circuit breaker, such as a compact circuit breaker/molded case circuit breaker (=MCCB), an open circuit breaker/air circuit breaker (=ACB) or a load break switch (=LBS);
a fault current protective switching device, in particular rated voltage-dependent fault current protective switching device;
a fire protection switching device/arc fault protective switching device/arc fault detection device;
a line protective switching device, in particular an electronic line protective switching device;
combined protective switching devices, such as a circuit breaker with fault current protection functionality, a fault current protective switching device with fire protection switching device functionality, a combined line, fault current and fire protection switching device, etc.

According to a first aspect of the invention, voltage and/or current values are monitored in a switching system and if a switching arc is detected on the basis of this monitoring, the burn time of the switching arc is measured. If the burn time of the switching arc is longer than a pre-defined time interval (“usual burn time of a switching arc”), this is assessed as a failing first protective switching device, i.e. as a protective switching device which is not capable of extinguishing a switching arc properly. In this case, backup protection is activated, in that a second protective switching device arranged upstream of the failing first protective switching device is caused to disconnect the current path to the failing first protective switching device, in order in this way to extinguish the switching arc.

According to a further aspect of the invention, an arc fault protection device which is configured to detect an arc fault in a switching system on the basis of voltage and/or current values in the switching system is used to perform backup protection for failing protective switching devices in the switching system. For this purpose, use can be made in particular of a constituent part of an arc detection algorithm of the arc fault protection device, which includes switching arc detection. Hitherto, this algorithm constituent part becomes active in order to prevent triggering of an arc fault protective switching device in the event that a switching arc occurs. According to the invention, this algorithm constituent part is set such that if a switching arc burns for longer than usual, for example in the event of failure of a protective switching device, this is interpreted as a system fault and a protective switching device arranged upstream of the failing protective switching device is caused to trigger.

The break time periods that can be achieved with the backup protection according to the invention are significantly shorter than the break time periods that can be achieved with conventional backup protection, which reduces the probability that a failing protective switching device will cause greater damage in the switching system. The triggering command of the arc fault protection device during such a failure of a protective switching device is set following the expiry of a typical triggering time for lower-order protective switching devices: if a switching arc continues to burn beyond a “usual” break time, this is judged by the arc fault protection device to be a fault of the responsible protective switching device, and an arc fault protective switching device triggers and clears the fault.

Advantageous refinements and developments of the invention are specified in the dependent claims. The method according to the invention can also be developed in accordance with the dependent device claims, and vice versa.

According to a preferred refinement, the switching system has a plurality of hierarchically structured distribution levels, wherein the second protective switching device is arranged at the hierarchically uppermost distribution level, and the first protective switching device is arranged at a distribution level arranged hierarchically below the uppermost distribution level. Preferably, this switching arc detection for the first distribution level in a switching system is attractive, since either ACBs that are not yet current-limiting or MCCBs that are less current-limiting, which have long delay times of the triggering for selectivity reasons, are installed there.

According to a preferred refinement, the second protective switching device is arranged immediately upstream of the first protective switching device. It is advantageous that only the parts of the switching system that are absolutely necessary to extinguish the switching arc are switched off, while the remaining parts of the switching system can continue to be operated without impairment.

A further solution to the object according to the invention is provided by an arc fault protection unit which has a data memory, a communications interface and a processor. The processor is configured to carry out the steps of the method as claimed in one of claims 1 to 3. The arc fault protection unit can be designed as a separate unit or integrated in a switching device.

According to a preferred refinement, a protective switching device has an arc fault protection unit as described above. The data memory, the communications interface and the processor of the arc fault protection unit are integrated in the protective switching device. The described method according to the invention is in this case also usable without a separate arc fault protection system and can be integrated into a switching device as a switching arc detection algorithm. The advantage is that a more compact construction of a switching system is possible.

According to a preferred refinement, the protective switching device which has an arc fault protection unit is the first or the second protective switching device. Thus the protective switching device itself can be the failing protective switching device or provide backup protection for a failing protective switching device.

A further solution of the object according to the invention is provided by an arc fault protection device. The arc fault protection device has an arc fault protective switching device. The arc fault protection device additionally has an arc fault protection unit as described above. Furthermore, the arc fault protection device has a sensor for measuring voltage and/or current values in an electrical line, a sensor line connecting the sensor to the arc fault protection unit for transmitting measured values from the sensor to the arc fault protection unit, and a control line connecting the arc fault protection unit to the arc fault protective switching device for transmitting at least one control signal from the arc fault protection unit to the arc fault protective switching device. The arc fault protective switching device is that protective switching device which provides backup protection for a failing protective switching device.

According to a preferred refinement, the at least one control signal is a triggering signal or a blocking signal. If, on the basis of voltage and/or current values in the switching system, it is detected that a switching arc that is occurring is extinguished properly, triggering of an upstream arc fault protective switching device can be prevented by a blocking signal. If, on the basis of voltage and/or current values in the switching system, it is detected that a switching arc that is occurring is not extinguished properly, an upstream arc fault protective switching device can be caused to trigger by a triggering signal. It is advantageous that an arc fault protection system can be used in two ways.

The method proposed can also be combined with an arc energy threshold, which is used in the following way: Following a detection of an arc fault in a switching system, this detection being carried out on the basis of an evaluation of electrical voltage and/or current values of the switching system, an interruption of the switching system to extinguish the arc fault is delayed until the energy liberated by the arc fault reaches a predefined threshold value. Thus, depending on which energy liberated by the arc fault in the switching system is tolerable at the different distribution levels of the switching system, the triggering signal from the arc fault protection unit to an arc fault protective switch in a higher-order level of the switching system is delayed and, in the meantime, a protective switching device in a lower-order level of the switching system is given time to clear the fault, i.e. the arc fault, before the triggering signal from the arc fault protection unit to the arc fault protective switch causes the entire switching system to be switched off. The selectivity in the switching system can therefore be ensured up to a defined level of damage, corresponding to the tolerated energy liberation from the arc fault.

The electrical switching system is hierarchically structured, i.e. it has a higher-order distribution level and one or more lower-order distribution levels. The switching system comprises a higher-order common main line, which is connected to an electrical energy source. The switching system additionally comprises a plurality of lower-order output lines, which originate from the common main line. The switching system additionally has a main switch for disconnecting the main line and a plurality of output switches for disconnecting a respective one of the output lines. The switching system also has at least one sensor for determining voltage and/or current values in the switching system, e.g. the main line or the output lines. The switching system additionally has an arc fault protection unit for detecting a switching arc in the switching system on the basis of electrical voltage and/or current values. The switching system further has a processor, which is configured to make the decision as to whether a protective switching device is caused to trigger to extinguish the switching arc on the basis of the determined voltage and/or current values.

According to a preferred refinement, a protective switching device is designed as a fuse.

The proposed arc fault protection unit can also be used for a further typical case of failure of a protective switching device. Often, the failure of a protective switching device is not caused by an extinguishing failure of a protective switching device but by a short circuit in the protective switching device or in the terminal area of the protective switching device, e.g. because of a defective insulation section: in these cases, the affected protective switching device cannot itself extinguish the short circuit. The combined switching arc-arc fault algorithm can also react promptly here, since the transverse or terminal short circuit caused by the switching arc corresponds to the characteristic of an arc fault and is therefore reliably recognized.

A further preferred refinement of the invention is a computer program product, comprising commands which have the effect that the arc fault protection unit carries out the method steps according to the invention.

A further preferred refinement of the invention is a computer program product which can be loaded directly into the internal memory of a digital computing unit and comprises software code sections with which the method, as described above, is carried out.

The computer program product is designed to be executable in a processor. The computer program product can be designed to be storable as software or firmware in a memory and to be executable by an arithmetic logic unit. Alternatively or additionally, the computer program product can also be designed, at least partly, as a hard-wired circuit, for example as an ASIC. The computer program product is designed to receive measured values acquired by sensors, to evaluate them and to generate control commands to switches or switching devices of the energy distribution system. According to the invention, the computer program product is designed to implement and carry out at least one embodiment of the outlined method for extinguishing an arc fault. The computer program product can combine all the partial functions of the method, that is to say be designed monolithically. Alternatively, the computer program product can also be designed to be segmented and in each case distribute partial functions to segments which are executed on separate hardware. For example, part of the method can be carried out in a control unit, and another part of the method can be carried out in a higher-order control unit, such as a PLC or a computer cloud.

Also proposed is a computer program product which can be loaded directly into the internal memory of a digital computing unit and comprises software code sections with which the steps of the method described herein are carried out when the product runs on the computing unit. The computer program product can be stored on a data carrier, such as a USB memory stick, a DVD or a CD-ROM, a flash memory, EEPROM or an SD card. The computer program product can also be present in the form of a signal that can be loaded via a wire-bound or wire-free network.

The method is implemented for automatic execution, preferably in the form of a computer program. The invention is therefore, firstly, also a computer program with program code instructions that can be carried out by a computer and, secondly, a storage medium having such a computer program, that is to say a computer program product with program code means.

Instead of a computer program with individual program code instructions, the implementation of the method described here and below can also be carried out in the form of firmware. It is clear to those skilled in the art that, instead of an implementation of a method in software, an implementation in firmware or in firmware and software or in firmware and hardware is always also possible. Therefore, for the description presented here, it is intended to be true that other implementation possibilities, specifically in particular an implementation in firmware or in firmware and software or in firmware and hardware, are comprised by the term software or the term computer program.

The above-described characteristics, features and advantages of this invention and the manner in which these are achieved will become clearer and considerably more comprehensible through the following description, which is explained in more detail with reference to the drawing. In the drawing, in each case schematically and not true to scale,

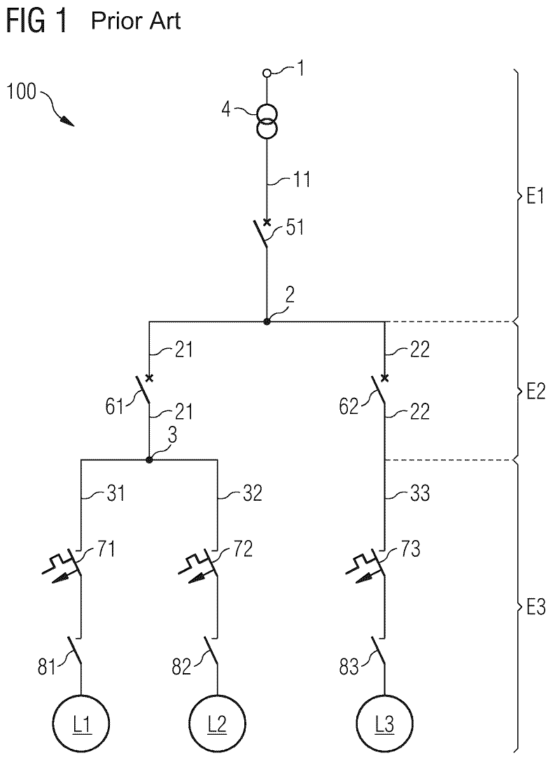

FIG. 1 shows a conventional electrical switching system;

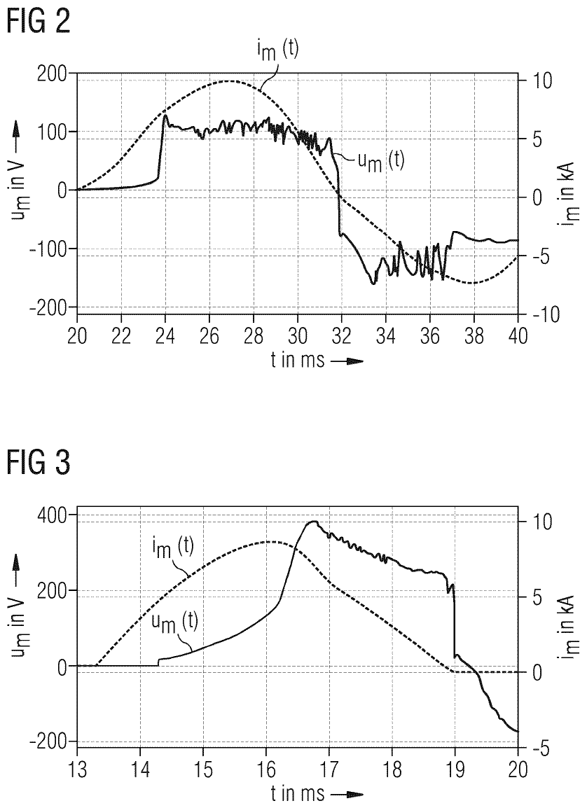

FIG. 2 shows a first graph of the variation in voltage and current over time during arc fault ignition,

FIG. 3 shows a first graph of the variation in voltage and current over time during switching arc ignition,

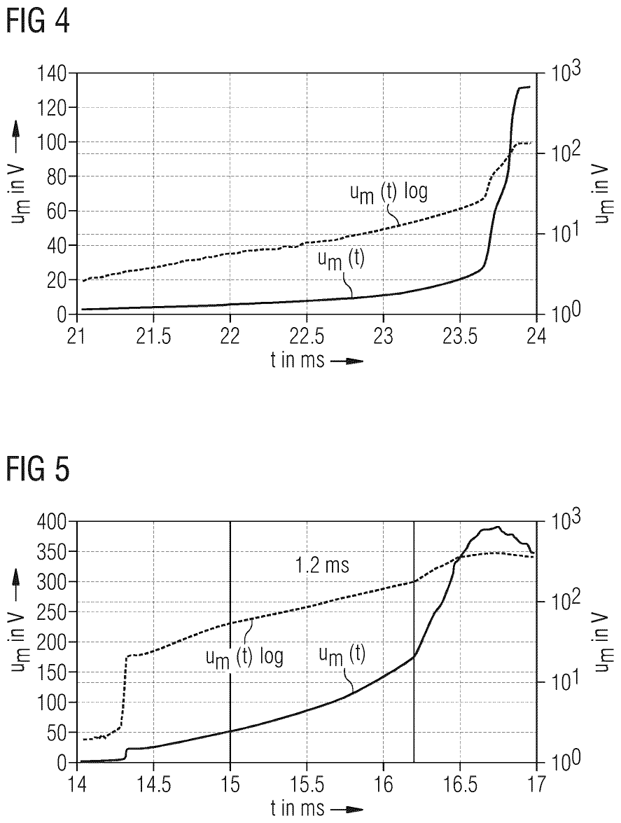

FIG. 4 shows a semi-logarithmic graph of the variation in voltage over time during arc fault ignition,

FIG. 5 shows a semi-logarithmic graph of the variation in voltage over time during switching arc ignition,

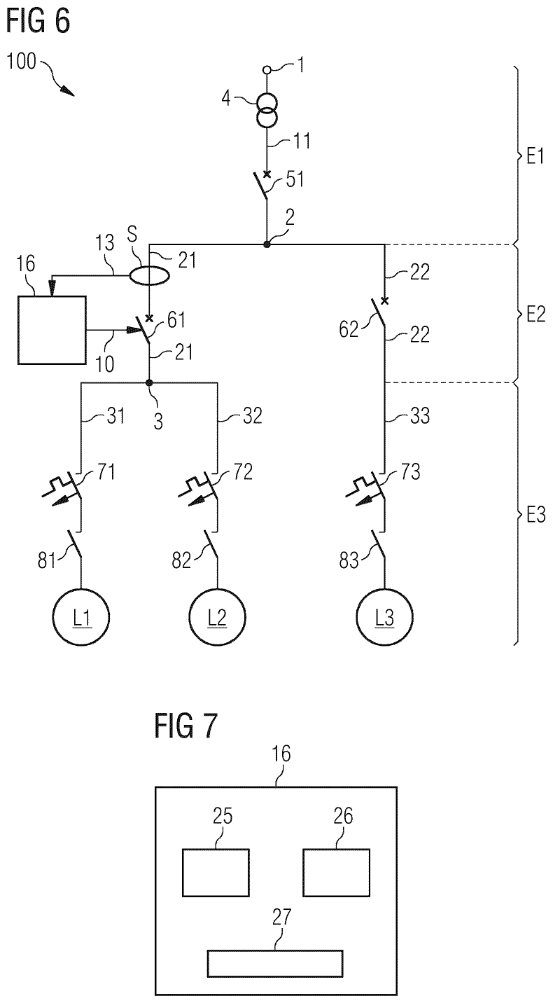

FIG. 6 shows an electrical switching system according to the invention;

FIG. 7 shows an arc fault protection unit;

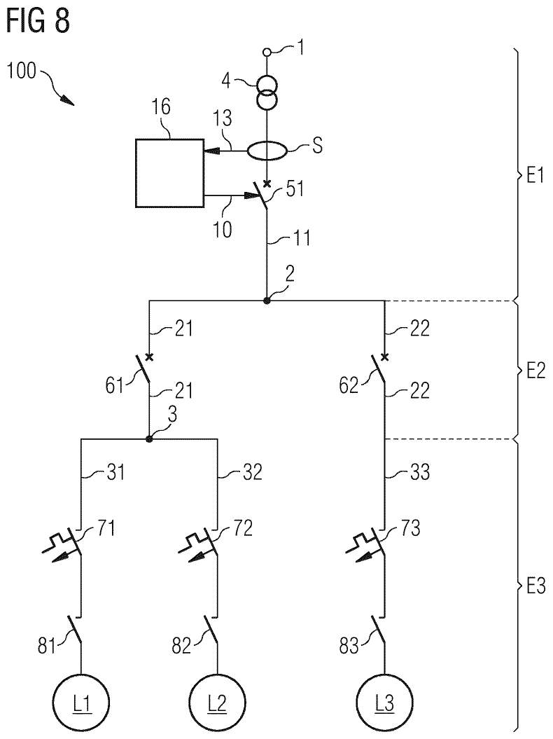

FIG. 8 shows an electrical energy distribution system according to an alternative embodiment;

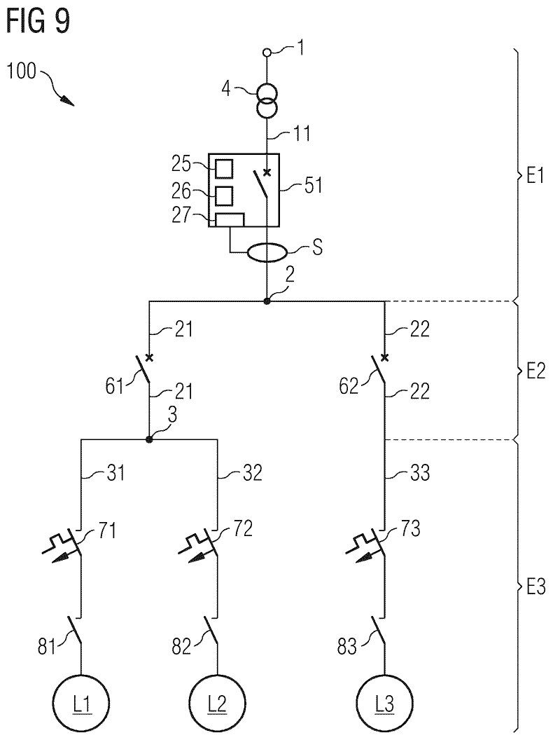

FIG. 9 shows an electrical energy distribution system according to a further alternative embodiment; and

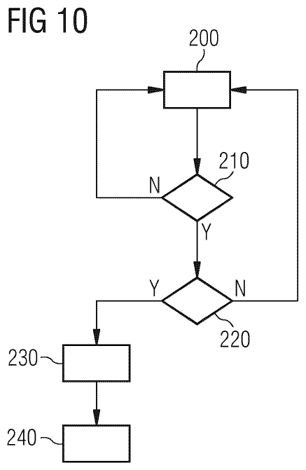

FIG. 10 shows a flowchart of an algorithm for carrying out a method according to the invention.

A conventional switching system 100 having a switch cascade over three distribution levels E1, E2, E3 is illustrated in FIG. 1. The switching system 100 is an electrical energy distribution system, in which electrical energy from an electrical energy source is distributed to electrical consumers via a line network having higher-order and lower-order lines. The switching system 100 has a current-carrying electrical main line 11 (also designated as: a main distribution line) having a feed point 1, at which the switching system 100 can be connected to a higher-order distribution network, for example a medium or high voltage network. Arranged after the feed point 1 is a transformer 4 for voltage conversion, for example from a medium or high voltage (AC voltages greater than 1000 V and DC voltages greater than 1500 V) of a higher-order distribution network to a low voltage (AC voltages up to 1000 V and DC voltages up to 1500 V) of the electrical switching system 100, and a protective switching device of the first, highest distribution level E1, the so-called main level, in the form of a main switch 51, which is formed as a circuit breaker, in the main line 11. In an alternative embodiment, the main switch 51 can be designed as a short-circuiting device or as a combination of a line switch and a short-circuiting device which are connected in series in the main line 1. Downstream of the main switch 51, the main line 11 has a first branching node 2, which forms a connection between the main line 11 and two output lines 21, 22. In each of the output lines 21, 22, there is a protective switching device of the second, central distribution level E2 in the form of circuit breakers 61, 62, which protect the respective output line 21, 22 against damage by excessively high heating as a result of over-current and automatically disconnect the line in the event of a short circuit.

Downstream of the first circuit breaker 61, the first output line 21 has a second branching node 3, which forms a connection between the first output line 21 and two secondary lines 31, 32, namely a first secondary line 31 and a second secondary line 32. In each of the two secondary lines 31, 32 there is a protective switching device at the third, lowest distribution level E3 in the form of line protective switching devices 71, 72: LP switches for short, which protect the respective secondary line 31, 32 against damage by excessively high heating as a result of over-current and disconnect the line automatically in the event of a short circuit.

Downstream of the second circuit breaker 62, the second output line 22 is connected to a third secondary line 33. In the third secondary line 33 there is a third LP switch 73, which protects the third secondary line 33 against damage by excessively high heating as a result of over-current and disconnects the line automatically in the event of a short circuit.

A respective electric consumer L1, L2, L3 is connected downstream of the individual secondary lines 31, 32, 33, each of which can be electrically connected to the secondary lines 31, 32, 33 or electrically isolated from the secondary lines 31, 32, 33 by a switch 81, 82, 83, for example a relay or a contactor. These consumers L1, L2, L3 can be electric motors, lights, electric heaters or other electrical loads.

The common main distribution line 11 and the separate output lines 21, 22 and secondary lines 31, 32, 33 can be configured for single-phase or multi-phase power conduction from the feed point 1 to the electrical loads L1, L2, L3. For a single-phase power line, it is sufficient for the lines 11, 21, 22, 31, 32, 33 each to have a single power conductor and optionally a current return conductor or a neutral conductor. For a three-phase power line, i.e. in a three-phase network for three-phase alternating current, it is sufficient for the lines 11, 21, 22, 31, 32, 33 each to have three separate power conductors-in each case one conductor for one of the three power phases; in addition there can be a neutral conductor.

These protective switching devices 51, 61, 62, 71, 72, 73 can also be designated as protective switching apparatuses, protective devices or simply as protective switches; the protective switching devices can be designed as circuit breakers, line protection switches or other protective switching devices, which are designed to disconnect the power in the power line in the event of an over-current in a power line, be it as a galvanically isolating switch (mechanical switch) or as an electronically isolating switch (semiconductor switch). They can also be designed as fuses, e.g. LV-HRC fuses (LV-HRC =low-voltage high rupture current). The protective switching device 51, 61, 62, 71, 72, 73 of the electrical line network 100 are cascaded and protect the network 100 and/or the electrical consumers L1, L2, L3 connected thereto selectively, i.e. in the event of a fault, for example an over-current, only that protective switching device of the protective switching devices 51, 61, 62, 71, 72, 73 which is located nearest to the fault location (=location of the fault) on its feed side switches off (=over-current selectivity). A fault location in an electrical line has a feed side, i.e. the current path in the direction of the feed, and a load side, i.e. the current path in the direction of the load; a protective switching device is arranged upstream of the fault, more precisely: the fault location, if it is located on the feed side of the fault. Only if the power is not switched off immediately by a protective switching device arranged immediately upstream of the fault location, because of a failure of this protective switching device, is the power switched off—with a time delay—by a protective switching device arranged upstream of the failing protective switching device (=backup protection). In this way, the selectivity in the electrical switching system 100 is ensured and achieved, since only the faulty part of the switching system 100 fails; the remainder of the switching system 100 remains operationally ready.

FIG. 6 shows an electrical switching system 100 according to the invention, which has all the features of the switching system 100 illustrated in FIG. 1 (to this extent, reference is made to the corresponding figure description) and, in addition, an arc fault protection unit 16, a sensor S arranged on the first output line 21 for determining voltage and/or current values in the first output line 21, a sensor line 13 connecting the sensor S to the arc fault protection unit 16 for transmitting the measured values acquired by the sensor S to the arc fault protection unit 16, and a control line 10 connecting the arc fault protection unit 16 to the first circuit breaker 61 for transmitting control signals, for example a triggering signal or a blocking signal, from the arc fault protection unit 16 to the protective switching device 61 arranged in the first output line 21.

As illustrated in FIG. 7, the arc fault protection unit 16 has a processor 26, a memory 25 and an interface 27. The arc fault protection unit 16 is configured to detect the burning of an arc fault in the energy distribution system 100 on the basis of electrical voltage and/or current values which have been measured by the sensor S in the main line 51. A current and voltage curve which has a significant variation can be measured in a circuit or line network in which an arc is burning. A typical time/voltage curve uₘ (t) and a time/current curve iₘ (t) for an arc fault are illustrated in FIG. 2. This shows an illustration of a graph in which the variation of the electrical voltage U and of the electrical current I over time following the ignition of an arc or arc fault, in particular parallel arc faults, in an electrical circuit, in particular a low-voltage circuit, is illustrated.

The time t in milliseconds (ms) [t in ms] is illustrated on the horizontal x-axis. The magnitude of the electrical voltage uₘ in volts (V) [uₘ in V] is depicted on the vertical Y axis on the left hand scale. The magnitude of the electrical current iₘ in kiloamperes (kA) [iₘ in kA] is depicted on the right-hand scale.

Following arc ignition, the current I runs on approximately sinusoidally. The voltage U runs in a highly distorted manner, approximately in a zig-zag shape with rapid voltage changes. Interpreted roughly, the voltage curve is rectangular to a first approximation, instead of a conventional sinusoidal curve. Viewed in abstract, a rectangular form can be detected in the voltage curve, which exhibits a highly stochastic proportion on the plateau. The rectangular form is characterized in that during the arc ignition and in the following zero crossings of the alternating voltage, significantly increased voltage changes occur, which are designated as a voltage jump below, since the rise in the voltage change is substantially higher as compared with a sinusoidal voltage curve.

FIG. 3 shows a graph of the voltage and current curve over time according to FIG. 2, with the difference of switching arc ignition.

If the curves according to FIGS. 2 and 3 are represented semi-logarithmically, then, according to FIGS. 4 and 5, the behavior in the voltage curve that is typical for a switching arc and deviates from an arc fault is exhibited.

FIG. 4 shows an illustration of the voltage curve over time uₘ(t), uₘ(t) log during arc fault ignition according to FIG. 2, firstly in a linear uₘ(t) and secondly in a semi-logarithmic uₘ(t) log depiction. The time t in milliseconds (ms) [t in ms] is illustrated on the horizontal x-axis. The magnitude of the electrical voltage uₘ in volts (V) [uₘ in V] is depicted in a linear illustration on the vertical Y axis on the left-hand scale. The magnitude of the electrical voltage uₘ in volts (V) [uₘ in V] is depicted in a logarithmic illustration on the right-hand scale.

FIG. 5 shows a graph according to FIG. 4, with the difference of switching arc ignition.

FIGS. 2 to 5, which show arbitrarily selected examples of possible arc voltage curves and arc current curves, idealized under certain circumstances, serve only to illustrate the fact that it is therefore possible in a circuit or an electrical network to detect the burning of an arc fault by using current and/or voltage values. Such a method for arc fault detection is described, for example, in DE102016209445A1 (Applicant: Siemens AG; TU Dresden: inventors: Wenzlaff et al.) 2017.11.30.

6 FIG. 7 shows an arc fault protection unit 16, which has a data memory 25, a processor 26 and a communications interface 27. Via the communications interface 27, the arc fault protection unit 16 is able to receive data, for example current and voltage measured values from sensors, or computer programs from higher-order entities, such as a control center or a control device, and transmit data, for example control signals to switches. Data can be stored in the data memory 25, for example current and voltage measured values acquired by sensors, preferably maximum tolerable burn times of switching arcs in protective switching devices of the switching system, predefined by a user of the arc fault protection unit or one or more computer programs. The processor 26 can execute computing steps, for example load a computer program deposited in the data memory 25 into a working memory of the processor 26 and process it as a computational algorithm. The processor 26 can also compare a measured burn time of a switching arc with a threshold value stored in the data memory 25. The communications interface 27 serves as an interface of the arc fault protection unit 16 for communication with communication partners, for example for receiving current and voltage measured values from a sensor which is configured to acquire current and voltage measured values from the switching system.

FIG. 8 shows an electrical switching system 100 according to the invention, which has all the features of the switching system 100 illustrated in FIG. 6 (to this extent, reference is made to the corresponding figure description), with the difference that the arc fault protection unit 16 is arranged at the hierarchically uppermost distribution level E1.

FIG. 9 shows an electrical switching system 100 according to the invention, which has all the features of the switching system 100 illustrated in FIG. 8 (to this extent, reference is made to the corresponding figure description), with the difference that the functions of the arc fault protection unit which, in the exemplary embodiment according to FIG. 8, is designed as a separate unit, are integrated into the protective switching device 51 of the hierarchically uppermost distribution level E1. Thus, the protective switching device 51 has a data memory 25, a processor 26 and a communications interface 27. The protective switching device 51 receives via its communications interface 27 voltage and/or current values from a current and/or voltage sensor S, which acquires these measured values on the power line 11 which can be switched by the protective switching device 51. These measured values are evaluated in the processor 26 of the protective switching device 51.

If the result of the testing method of the processor 26 is that a switching arc in a first faulty protective switching device 61, 62, 71, 72, 73 of the switching system 100 burns for longer than a predefined time period, then the processor 26 causes a disconnection of the power line 11 by means of the protective switching device 51, for example by opening galvanic contacts or by blocking a semiconductor switch of the protective switching device 51. Since the protective switching device 51 is located at the uppermost distribution level, the protective switching device 51 is in every case a protective switching device which is arranged upstream of the faulty protective switching device.

FIG. 10 shows a possible method sequence which, for example, can be implemented in the form of an algorithm. In a first step 200, current and/or voltage values are acquired by a sensor on a current-carrying line of the switching system, preferably on the main line. In a following step 210, on the basis of the acquired current and/or voltage values, a check is made as to whether a switching arc is burning in a first protective switching device of the protective switching devices of the switching system 100. If no (N), a jump is made to step 200 again. If yes (Y), this time to of the detection is stored as the ignition time of the switching arc. In a following step 220, at a following time t1=t0+Δt, a check is made as to whether the switching arc is still burning in the first protective switching device. The time interval Δt is a predefined value, e.g. 6-7 ms, which corresponds to a no longer tolerable burn time of a switching arc, since a switching arc is normally extinguished after a burn time of, for example, 5 ms.

If the switching arc is no longer burning (N), a jump is made to step 200 again. If the switching arc is still burning (Y) in the first protective switching device, in step 230 a triggering command is sent out to a second protective switching device which is arranged upstream of the first protective switching device. As a result of the triggering of the second protective switching device, an area of the switching system 100 that is downstream of the second protective switching device is de-energized, and the switching arc which is burning in this area of the switching system is extinguished in step 240.

1-10 (canceled)

11. A method for backup protection in an electrical switching system (100), the method comprising:
providing a second protective switching device upstream of a first protective switching device of the switching system;
checking, based on at least one of electrical voltage values or electrical current values of the switching system, whether or not a switching arc burns for longer than a predefined time in the first protective switching device of the switching system; and
when the switching arc burns for longer than the predefined time, causing the second protective switching device, which is arranged upstream of the first protective switching device, to trigger.

12. The method according to claim 11, wherein the switching system has a plurality of hierarchically structured distribution levels, with the second protective switching device being arranged at a hierarchically uppermost distribution level and the first protective switching device being arranged at a distribution level that is arranged hierarchically below the uppermost distribution level.

13. The method according to claim 11, which comprises arranging the second protective switching device immediately upstream of the first protective switching device.

14. An arc fault protection unit comprising a data memory, a communications interface, and a processor configured to carry out the method according to claim 11.

15. A protective switching device, comprising an arc fault protection unit having a data memory, a communications interface, and a processor configured to carry out the method according to claim 11.

16. The protective switching device according to claim 15, wherein the protective switching device is the first protective switching device or the second protective switching device.

17. An arc fault protection device, comprising:
an arc fault protective switching device;
an arc fault protection unit having a data memory, a communications interface, and a processor;
a sensor for measuring at least one of voltage values or current values in an electrical line;
a sensor line connecting said sensor to said arc fault protection unit, for transmitting measured values from said sensor to said arc fault protection unit; and
a control line connecting said arc fault protection unit to said arc fault protective switching device, for transmitting at least one control signal from said arc fault protection unit to said arc fault protective switching device; and
wherein the arc fault protective switching device is the second protective switching device according to claim 11.

18. The arc fault protective switching device according to claim 17, wherein the at least one control signal is a triggering signal or a blocking signal.

19. A non-transitory computer program product, comprising computer-executable commands to be executed on an arc fault protection device having an arc fault protective switching device, an arc fault protection unit with a data memory, a communications interface, and a processor, a sensor for measuring at least one of voltage values or current values in an electrical line, a sensor line connecting the sensor to the arc fault protection unit, for transmitting measured values from the sensor to the arc fault protection unit, and a control line connecting the arc fault protection unit to the arc fault protective switching device, for transmitting at least one control signal from the arc fault protection unit to the arc fault protective switching device; and
to cause the arc fault protection unit to carry out the method according to claim 11 when the commands are executed on the arc fault protection device, and the arc fault protective switching device is the second protective switching device.

20. A non-transitory computer-readable medium having stored thereon the computer program product according to claim 19.
